(19) United States
(12) Patent Application Publication
(10) Pub. No.: US 2001/0035869 A1
(43) Pub. Date: Nov. 1, 2001

(54) Image recording and replay apparatus

(75) Inventor: Osamu Ikeda, Yokohama-shi (JP)

Correspondence Address: OLIFF & BERRIDGE, PLC, P.O. Box 19928, Alexandria, VA, 22320, US

(73) Assignee: NIKON CORPORATION, Chiyoda-Ka (JP)

(21) Appl. No.: 09/891,405

(22) Filed: Jun. 27, 2001

Related U.S. Application Data
(63) Continuation of application No. 08/949,706, filed on Oct. 14, 1997.

(30) Foreign Application Priority Data
Oct. 15, 1996 (JP) 08-272413

(51) Int. Cl. G09G 5/00

(52) U.S. Cl. 345/619

(57) ABSTRACT

An image recording and replay apparatus can record a line drawing in stages and can reproduce the line drawing in stages so that it appears as if the line drawing is being drawn. A position input device externally takes in position coordinates from a screen. A recording device records the position coordinates taken in by the position input device in a recording medium corresponding to the order they were taken-in. An image drawing device reads out the position coordinates recorded by the recording device and draws an image by sequentially re-writing on the screen points corresponding to the position coordinates in the order in which the position coordinates were taken in by the position input device.

The disclosure of the following priority application is herein incorporated by reference: Japanese Patent Application No. 8-272413, filed Oct. 15, 1996.

### BACKGROUND OF THE INVENTION

1. Field of Invention

The present invention relates to an image recording and replay apparatus that records and replays images, and in particular, to an image recording and replay apparatus that records and replays line drawings.

2. Description of Related Art

In general, image recording and replay apparatus are known that input a line drawing using a tablet (e.g., a touch tablet). In this type of tablet input image recording and replay apparatus, the line drawing can be drawn on the screen by writing on the tablet with, e.g., a light pen or the like.

However, in the conventional image recording and replay apparatus which uses a tablet, only the completed line drawing is recorded as an image in memory. Because of this, the process of drawing a line drawing from start to completion cannot be reproduced.

In order to produce (and display) the process of drawing the line drawing using a conventional image recording and replay apparatus, the line drawing being produced had to be completed little by little (i.e., in stages), with each stage being saved, one by one as separate files. Consequently, the number of image files created was equal to the number of times the line drawing was saved. This would require a series of user input commands to save the image (one for each stage).

Additionally, the replay operation had to be performed one by one for each of these image files, with a separate user input command to display each image. The line drawing process could not be replayed smoothly from the beginning of the drawing until the end of the drawing.

### SUMMARY OF THE INVENTION

In order to solve the above and other problems, an image recording and replay apparatus of the invention not only records and replays a completed line drawing, but also reproduces the intermediate stages of the image drawing process. A position input device, such as, for example, a touch panel or a mouse, allows an operator to input position coordinates on a screen. The position input device sequentially takes in these position coordinates over time. A recording device sequentially records the position coordinates that are taken in via the position input device to a memory where they are stored along with information (e.g., pointers) relating to the take-in order. Thus, the memory stores information relating to the position coordinates in a time sequence. An image drawing device reads out the position coordinates recorded in the memory. Then, following the take-in order of the position coordinates, the image drawing device sequentially performs image drawing by drawing the points corresponding to those position coordinates on the screen.

Accordingly, on the screen, the intermediate stages of the line drawing process performed by the operator is realized (illustrated, or displayed) as if it is being drawn at that moment.

Preferably, the recording device automatically completes the recording of the position coordinates for a particular line drawing (storing these coordinates as a particular file) when a new position coordinate is not taken in (input) after a predetermined time period.

The image recording and replay apparatus also can include a sound replay device that reads out sound data recorded in the memory to replay the sound. The image drawing device can perform the read-out operation of the position coordinates in conjunction with the read-out operation of the sound replay device. Accordingly, the image drawing operation is performed along with and the sound replay operation.

Preferably, the image drawing device controls the replay period of the sound and the image drawing period so as to have approximately the same duration. Accordingly, the image drawing speed is automatically adjusted to conform with the length of the sound replay period.

### BRIEF DESCRIPTION OF THE DRAWINGS

The invention will be described in conjunction with the following drawings in which like reference numerals designate like elements and wherein:

FIG. 1 is a high-level functional diagram of aspects of the invention;

FIG. 2 is a block diagram of an embodiment of the invention;

FIG. 3 is a first flow chart explaining the operation of the embodiment;

FIG. 4 is a second flow chart explaining the operation of the embodiment;

FIGS. 5A-5B demonstrate a line drawing process and the recording of information according to an embodiment of the invention;

FIGS. 6A-6B show display screens;

FIGS. 7A-7B show display screens and demonstrate a line drawing process in which an error is corrected;

FIGS. 8A-8B show display screens of a completed line drawing;

FIGS. 9A-9B show display screens in which a line drawing is replayed; and

FIG. 10 shows a display screen of a completed, replayed line drawing.

### DETAILED DESCRIPTION OF PREFERRED EMBODIMENTS

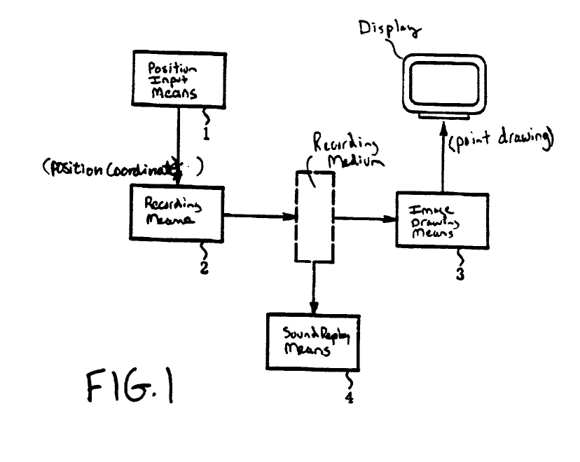

FIG. 1 is a high-level representation of aspects of the invention. The image recording and replay apparatus includes a position input means 1 that takes in a position coordinate externally provided to a screen. A recording means 2 records the position coordinates taken in by the position input means 1 onto a recording medium corresponding to the take-in order. An image drawing means 3 performs image drawing by sequentially rewriting on a display screen points corresponding to the position coordinates taken in by the recording medium 2.

According to one aspect of the invention, the recording of the position coordinates for a particular line drawing is completed when position coordinates have not been taken in for a predetermined time period.

According to another aspect of the image recording and replay apparatus of the invention, a sound replay means 4 is provided to read out sound data recorded in the recording medium and replay the sound data as sound. The image drawing means 3 can read out the position coordinates from the recording medium in parallel with the operation of the sound replay means 4 reading out the sound data from the recording medium. Preferably, the image drawing means 3 is capable of controlling the image drawing speed so that a sound replay period, during which sound is replayed by the sound replay means 4, matches the image drawing period. Thus, the line drawing will be completed at the same time that the sound reproduction is completed.

Hereafter, embodiments of the present invention are explained referring to the drawings. According to the illustrated embodiment, the image recording and replay apparatus is implemented in an electronic camera that is capable of recording and replaying still images and moving images.

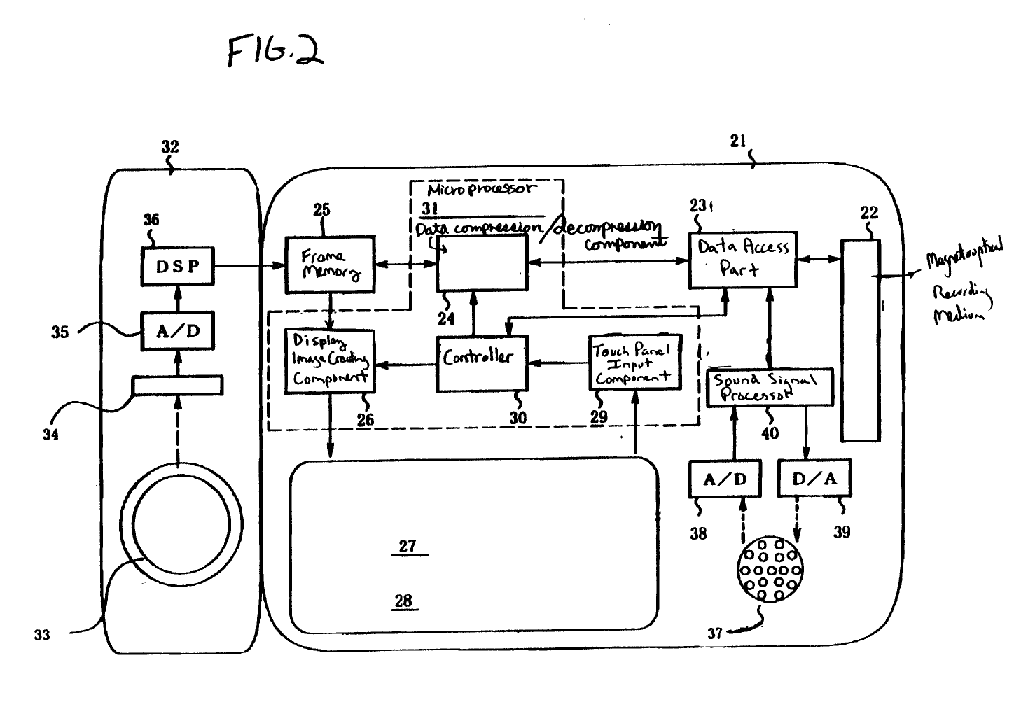

In the interior of the main body 21 of the FIG. 2 camera, a magnetooptical recording medium 22 is detachably provided. A data access component 23, which reads from and writes to the magnetooptical recording medium 22, is connected with a frame memory 25 via a data compression/decompression component 24. The output of the frame memory 25 is input to a liquid-crystal display component 27 via a display image creating component 26.

A touch panel 28 is provided for the liquid-crystal display component 27. The position information which is detected by the touch panel is input to a controller 30 via a touch panel input component 29. The output of the controller 30 is input to the data compression/decompression component 24 and to the display image creating component 26. The output of the controller 30 is also connected to the data access component 23.

The functions of the data compression/decompression component 24, the display image creating component 26, the touch panel input component 29 and the controller 30 are realized through a microprocessor 31.

A sound input/output component 37, which comprises a microphone and a speaker, also is provided in the main body 21. The output terminal of the sound input/output component 37 is connected to the input terminal of A/D converter 38. The input terminal of the sound input/output component 37 is connected to the output terminal of D/A converter 39.

The A/D converter 38 and the D/A converter 39 are connected to a sound signal processor 40. The sound signal processor 40 also is connected to the data access component 23.

A camera component 32, which is attached to the main body 21, is provided with a photograph lens 33. An imaging element 34 is arranged in a position to receive light from the object, which is obtained via the photograph lens 33. The imaging component 34 is a CCD (Charge Coupled Device), which is a photoelectric converter in that it converts light images to electrical (image) signals. Other photoelectric converters include CMOS devices and PSDs (Photo-Sensitive-Diodes).

The output signal of the imaging element 34 is input to the frame memory 25 via A/D converter 35 and a digital signal processor (DSP) 36.

With respect to the high-level representation of FIG. 1, the position input means 1 includes the touch panel 28. The recording means 2 includes the data access component 23, the touch panel input component 29 and the image drawing data creation function performed by the controller 30. The image drawing means 3 includes the data access component 23, the display image creation component 26 and the reading out function of the image drawing data performed by the controller 30.

The sound replay means 4 includes the data access component 23, the reading out function of the sound data performed by the controller 30, the sound input/output component 37, the D/A converter 39 and the sound signal processor 40.

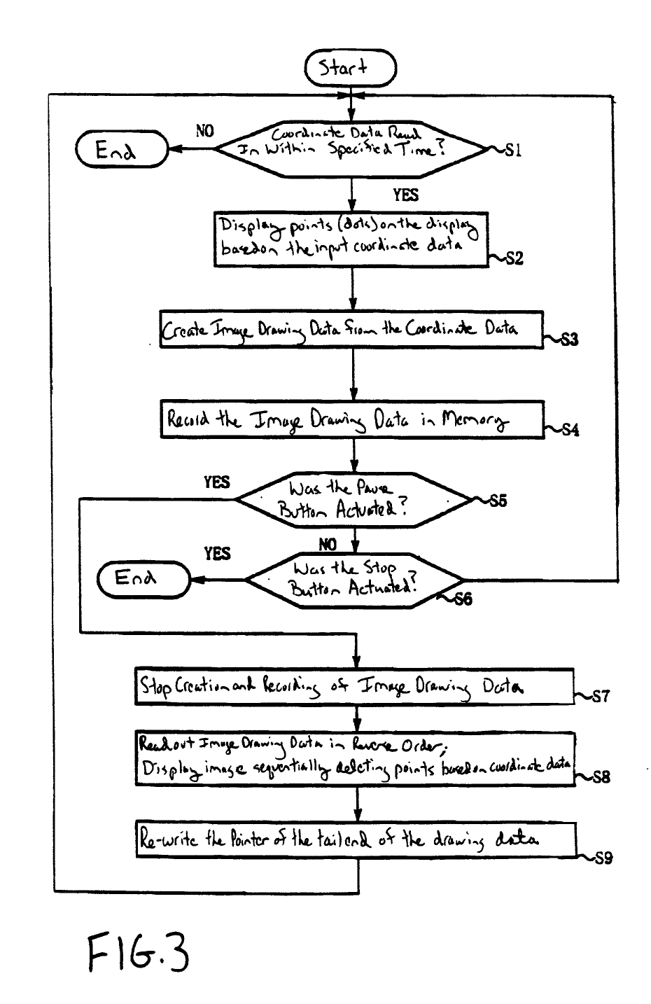

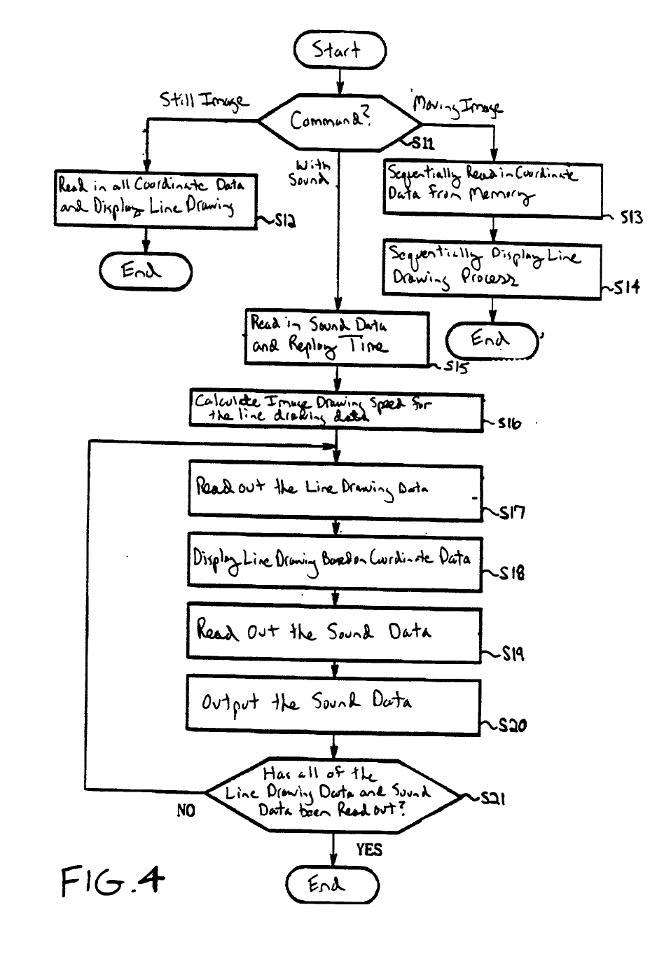

FIG. 3 and FIG. 4 are flow charts explaining the operation of the embodiment. The operations of the embodiment are now explained referring to FIGS. 2-10.

The magnetooptical recording medium 22 is provided in the main body 21.

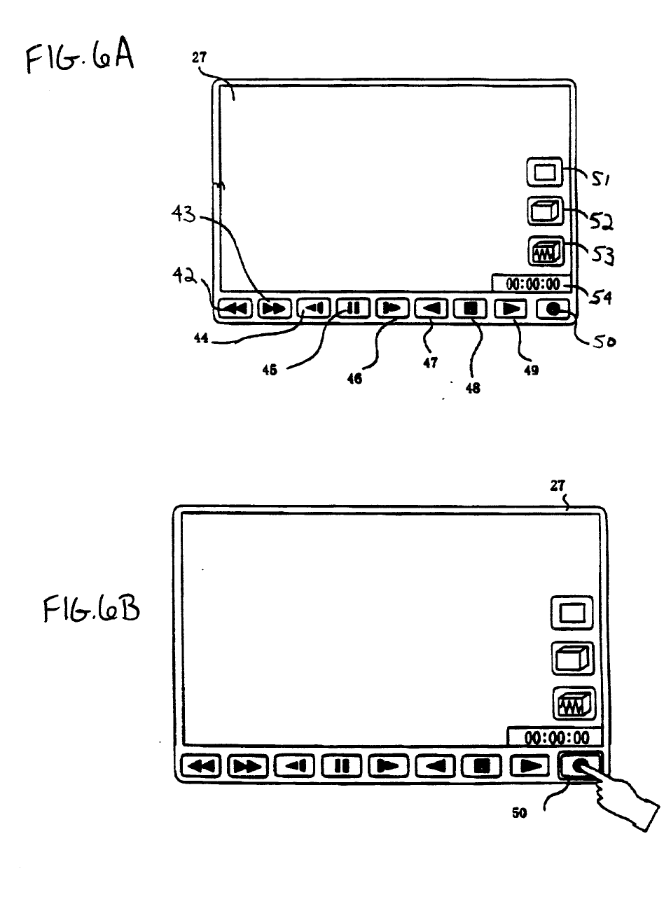

FIG. 6A shows the initial screen displayed in the liquid crystal display component 27.

The operation button for recording and replaying is arranged in the lower part of the screen of the liquid crystal display component 27. The following buttons are provided, starting on the left: a reverse button 42, a fast forward button 43, a reverse slow-motion button 44, a pause button 45, a slow-motion button 46, a reverse replay button 47, a stop button 48, a replay button 49 and a recording button 50.

At the right side of the screen of the liquid crystal display component 27 are arranged, from the top, a still image replay button 51, a moving image replay button 52, a replay-with-sound button 53 and a clock counter component 54.

When these operation buttons are operated, the buttons are switched to a highlighted display, and their respective conditions are displayed.

The operations of all the operation buttons are performed via the touch panel 28 or the like; which uses well known GUI (Graphical User Interface) technology. In short, in the liquid crystal display component 27, the operation buttons are displayed as objects, and the touch panel 28 and the touch panel input component 29 sense the contact operation of the operator with respect to these objects. As opposed to a touch panel, the invention also can be implemented using a mouse or other input device to move a cursor over desired icons, which are then selected by clicking, for example.

The controller 30, corresponding to this contact (or selection) operation, generates a set message relating to the object on the screen. The display image creating component 26 receives that message, and, for example, changes the screen display. The data access component 23 performs a reading operation that corresponds to that message.

When the operator touches a button via the touch panel 28, a voltage is generated by the touch panel 28 being pressed. The signal representing that voltage is conveyed to the controller 30 via the touch panel input component 29. As illustrated in FIG. 6B, the controller 30 recognizes the fact that the recording button 50 is pressed based upon that signal, and starts the recording of the line drawing. When the operator touches the touch panel 28, the touched positions are input to the controller 30 via the touch panel input component 29 as point information such as a position coordinate data (X, Y).

If it is determined in step S1 that coordinate data has been input within a specified time, flow proceeds to step S2. In step S2, the display image creating component 26 sequentially displays points or combinations of points (such as lines) on the liquid crystal display component 27 based upon the coordinate data which is obtained via the controller 30. At this time, the points are sequentially displayed on the liquid crystal display component 27 at exactly the same position as the position that the operator touched on the touch panel 28. By repeating this operation, the operator can draw the line drawing via the touch panel 28. The time interval by which the position coordinates are taken from the touch panel 28 (hereafter, “sampling interval time”) is, for example, a time interval of 5 ms.

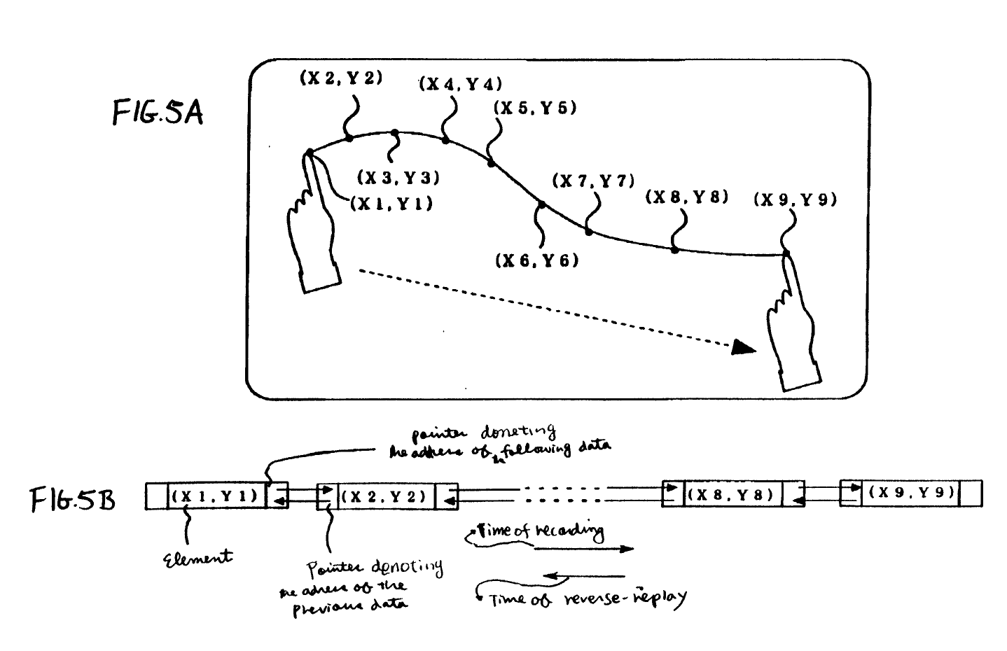

The controller 30 creates the image drawing data from the obtained coordinate data. As illustrated in FIG. 5A, assume that the controller 30 took in the coordinate data of the positions (X1, Y1) through (X9, Y9). Since the sampling interval time is a certain time, if there is a distance between the data of (X8, Y8) and (X9, Y9), the control is able to determine that the operator drew a line quickly in that interval.

As illustrated in FIG. 5B, the controller 30, with the coordinate data as an element, creates bi-directional list data by adding a pointer area which indicates the address (pointer) of the coordinate data input at the time interval that is one before and one after that coordinate data (step S3). Thus, for example, the coordinate position (X2, Y2) includes a first pointer pointing to positions (Xl, Y1) as the preceding position data and a second pointer pointing to position (X3, Y3) as the subsequent position data.

The controller 30 records this bi-directional list data as image drawing data in the magnetooptical recording medium 22 via the data access part 23 (step S4). Furthermore, between each coordinate data, the display image creating component 26 performs interpolation to draw a line segment.

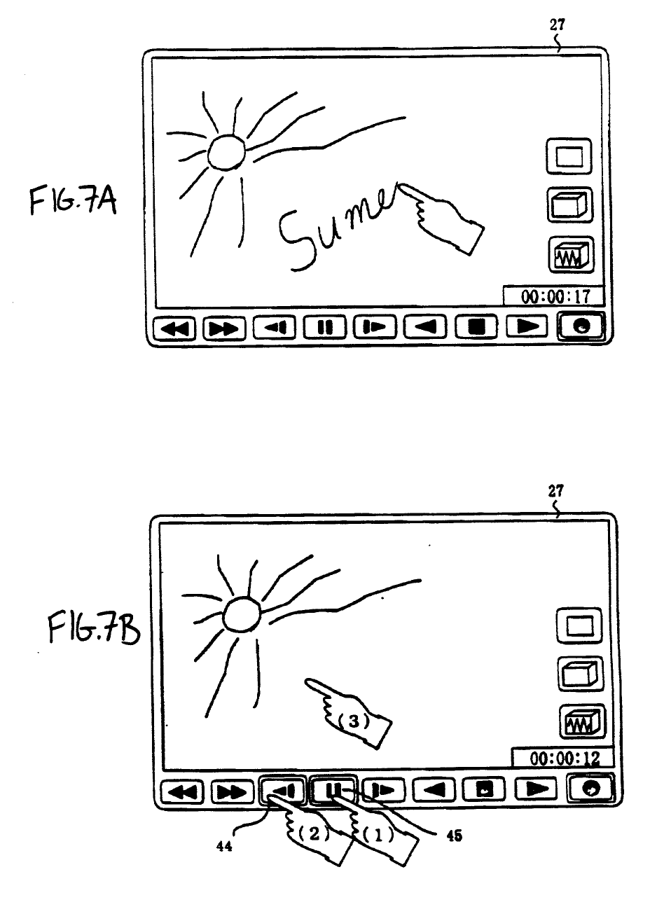

By the above mentioned operation, as shown in FIG. 7A, the image drawing data of the line drawing is recorded one by one in the magnetooptical recording medium 22 while the operator is drawing the line drawing.

When the operator wishes to re-draw the line drawing during recording of the line drawing, as illustrated in FIG. 7B (e.g., to make a correction to the line drawing), the operator touches the pause button 45 and the reverse slow-motion button 44 (the operation 1 and the operation 2). When the controller 30 recognizes that the pause button 45 is pressed (YES in step S5), the controller 30 stops the creation and the recording of the image drawing data (step S7). Additionally, when the controller 30 recognizes that the reverse slow motion button 44 is pressed, it reads out the image drawing data which is recorded in the magnetooptical recording medium 22 in the reverse direction rather than in the recorded order. Since the image drawing data is a bi-directional direction list, it is possible to sequentially read out the data starting from the end-point data by following the pointers. The controller 30 seeks the latest recorded data, and reads out in the reverse direction rather than in the recorded direction.

The controller 30 outputs the coordinate data to the display image creating component 26 from the readout image drawing data. At this time, the controller 30 orders the display image creating component 26 to sequentially (in reverse order) delete the points displayed for the coordinate data. The display image creating component 26 sequentially deletes the displayed points, in accordance with the read out coordinate data. Accordingly, the reverse replay is performed, and the points sequentially disappear from the locations that the operator just drew (step S8).

The above-mentioned reverse replay operation continues until the pause button 45 is pressed again. When the operator returns to the point that he wants to amend, and the pause button 45 is pressed again, the controller 30 recognizes that operation, and ends the reverse replay operation. Then, the controller 30 again returns to the condition in which the line drawing recording is possible. At this time, the end point of the data of the image drawing data at the time of the reverse replay becomes the last readout data from the magnetooptical recording medium 22.

When the operator again starts the image drawing (the operation 3 in FIG. 7B), the controller 30 starts taking in the coordinate data again via the touch panel 28 and the touch panel input component 29, and outputs that coordinate data to the display image creating component 26. Further, the controller 30 creates the image drawing data from the coordinate data, and records them in the magnetooptical recording medium 22 via the data access part 23.

It is possible to connect the newly created image drawing data to the last image drawing data by rewriting the pointer that indicates the address of the following data in the last image drawing data (step S9).

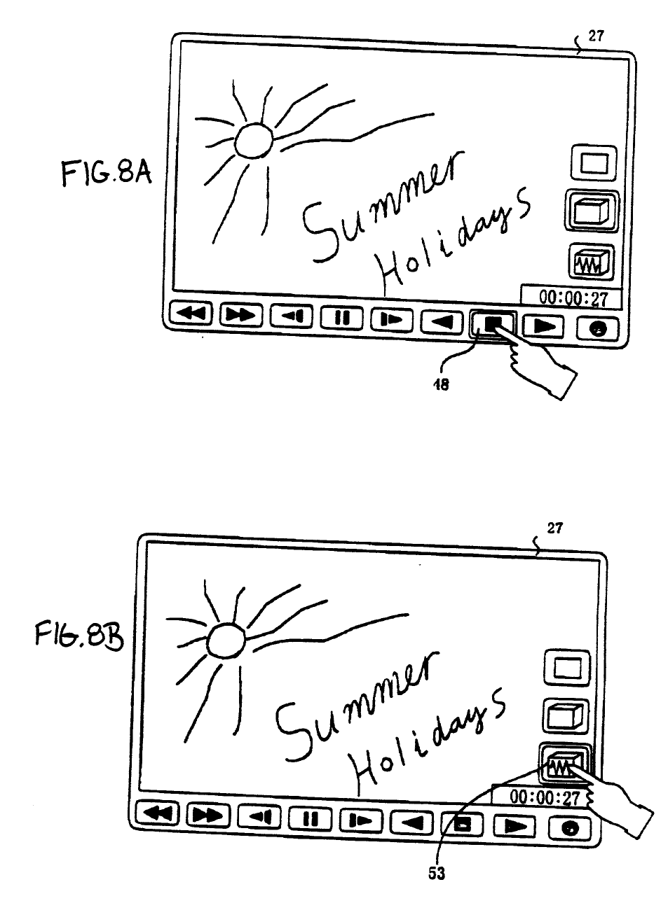

The controller 30 continues the taking in operation of the coordinate data. The creating and recording operation of the image drawing data are repeated until the stop button 48 is pressed (YES in step S6). The controller 30, as shown in FIG. 8A, automatically completes the creation and recording of the image drawing data when the stop button 48 is pressed (step S6) or when coordinate data is not taken in for a predetermined period (NO in step S1). When the creation or recording of the image drawing data is completed, the image drawing data is controlled as a single file.

Next, the replay operation is explained. The controller 30 determines which one of the still image replay button 51, the moving image replay button 52, or the replay button with sound 53 is pressed (step S11).

When the still image replay button is pressed, and the replay button 49 is pressed, the controller 30 recognizes that operation and reads out the image drawing data from the magnetooptical recording medium 22 via the data access part 23. The controller 30 converts the image drawing data to the coordinate data, and outputs it to the display image creating component 26. The display image creating component 26 reads in all the coordinate data, and creates the line drawing in a completed condition, and displays it on the liquid crystal display part 27 (step S12).

When the moving image replay button 52 is pressed, and the replay button 49 is pressed, the controller 30 recognizes that operation and reads out the image drawing data from the magnetooptical medium 22 via the data access part 23. At this time, the controller 30 reads out starting from the top data of the image drawing data in accordance with the pointers (step S13). The controller 30 converts the read out image drawing data to the coordinate data, and sequentially outputs this data to the display image creation component 26. The display image creation component 26 displays the points in accordance with the coordinate data, and performs the image drawing by writing additional successive points (step S14). Accordingly, the line drawing is replayed as if the operator is drawing.

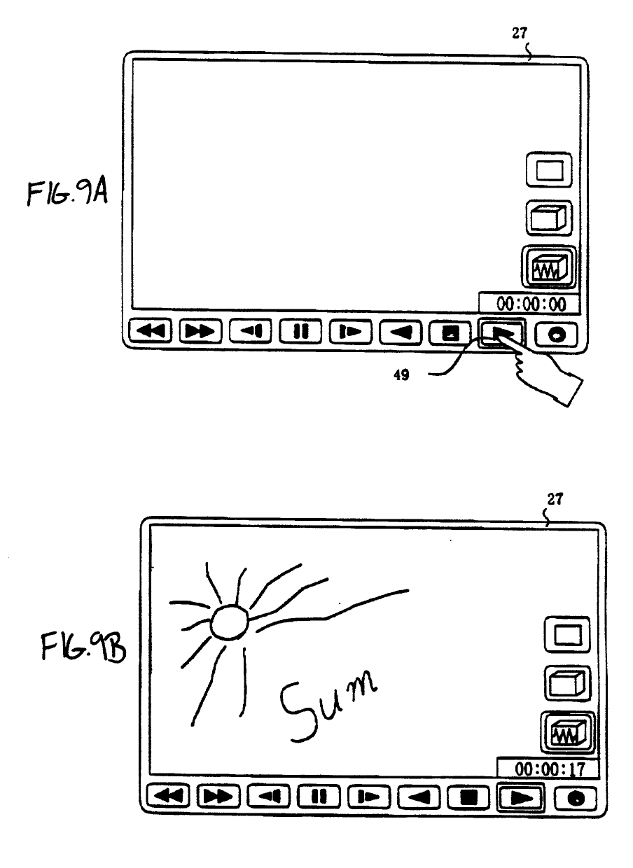

As shown in FIG. 8B and FIG. 9A, when the replay button 53 with sound is pressed, and the replay button 49 is pressed, the controller 30 recognizes that operation, and reads out the pre-recorded sound data via the data access part 23 (step S15). In this sound data, the replay time is recorded as an attribute of the file. The image drawing time is adjusted by the controller 30 based upon this replay time.

The controller 30 reads out the number of the image drawing data recorded in the magnetooptical recording medium 22, and calculates the point number of the image drawing (an image drawing speed) per second by dividing the number of image drawing data (the number of coordinates) by the sound replay time (step S16).

When performing a normal image drawing, since the sampling interval time is 5 ms, the display image creating component 26 performs the image drawing at 200 dots per second. When, for example, the image drawing time is longer than the sound replay time, the image drawing speed is made faster than 200 dots per second. When the image drawing time is shorter than the sound replay time, the image drawing speed is made slower than 200 dots per second. By performing these processes, the image drawing time and the sound replay time are made to match.

The controller 30 reads out the image drawing data from the magnetooptical recording medium 22 via the data access part 23. At this time, the controller 30 reads out the data from the top data of the image drawing data by sequentially following the pointers (step S17). When a certain amount of the image drawing data is read out, the controller 30 converts that data to the coordinate data, and sequentially outputs to the display image creating component 26. The display image creating component 26 displays the points by following the coordinate data being sent, and performs the image drawing with the calculated image drawing speed by writing additional successive points (step S18).

Next, the controller 30 seeks the sound data via the data access part 23, and performs the reading out of the sound data (step S19). The sound data which is read out for a certain amount by the data access part 23 is sent to the sound signal processing component 40, and then is passed through a filter and is amplified by the sound signal processing component 40 and the D/A converter 39, and is replayed as sound (step S20).

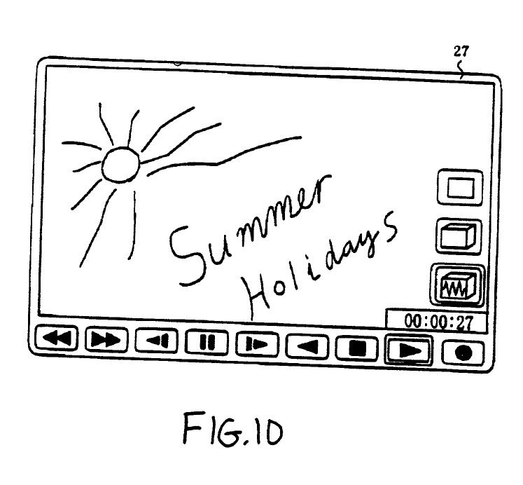

The image drawing operation and the sound replay operation are simultaneously performed by performing, in a time-divided manner, the reading operation of the image drawing data and the reading operation of the sound data described above as shown in FIG. 9B and FIG. 10. When all the image drawing data and the sound data are read out, the image drawing operation and the sound replay operation are completed (step S21).

In the described embodiment, external sound can be recorded. The sound obtained via the sound input/output component 37 is passed through a low pass filter, and is digitally converted at the A/D converter 38 and the sound signal processor 40. At this time, it is converted with a sampling frequency of 48 khz and 16 bits as the quantization bit number.

The sound data is recorded in the magnetooptical recording medium 22 with a file attribute, such as the file size, the date made and the replay time. This enables the performance of the replay of this sound data and the replay of the line drawing simultaneously.

The main body 21 includes the camera component 32, which has the imaging element 34 that photoelectrically converts the image obtained via the photographic lens 33. That signal is converted to a digital signal at the A/D converter 35. The digital signal processor 36 performs signal processing such as white balance adjustment, gamma correction and interpolation of pixels. The image signal is compressed at the data compression/decompression component 24 via the frame memory 25. The compressed data is recorded in the magnetooptical recording medium 22 via the data access part 23. When it is desired to display. a previously stored image, it is read from the magnetooptical recording medium 22, decompressed by component 24, and displayed. In this way, the photographic data of the frame memory 25 is monitor displayed at the liquid crystal display component 27 via the display image creating component 26.

In the present embodiment, the line drawing, which was drawn by the operator using the touch panel 28, can be sequentially replayed. Accordingly, the image is drawn out on the screen as if the operator is drawing the line drawing at that moment, and an interesting picture image can be obtained.

Moreover, a variety of image drawing replays can be performed since not only the sound is replayed simultaneously at the time of replay of the image drawing, but also the image drawing speed can be adjusted to correspond to the sound replay time.

Furthermore, since the touch panel can be formed integrally with the apparatus, an image recording and replay apparatus having a superior portability can be realized.

In the present embodiment, with respect to the magnetooptical recording medium 22, the reading-out operation of the image drawing data and the reading-out operation of the sound data occur in parallel by accessing the data in a time-divided manner. However, the present invention is not limited to this technique. For example, it is possible to provide another data access component (another reading device) for accessing the sound data.

In the present embodiment it is possible to reproduce how much time it took to draw the line drawing by making the sampling interval time constant. However, the present invention is not limited to this example. For example, the length of time required to draw the line drawing can be accurately reproduced by adding and recording to the coordinate data the time required for taking in the coordinate data.

Further, in the present embodiment, the image drawing speed is changed uniformly in correspondence with the sound replay time. However, the present invention is not limited to this example. For example, the image drawing speed can be made faster by thinning out the data from any parts that take too much image drawing time due to the high number of samples.

In the present embodiment, a touch panel was used as an input component. However, the present invention is not limited to this example. For example, a mouse can be used.

Furthermore, in the present embodiment, a magnetooptical recording medium is used as a memory. However, the present invention is not limited to this example. It is also possible to use other recording media such as, for example, magnetic recording medium, optical recording medium and semiconductor recording medium (i.e., flash memories). Moreover, the memory need not be removable from the apparatus.

In the present embodiment, the replay of a line drawing is described. However, the present invention is not limited to this example. The editing described below can be performed. For example, a line drawing can be added as a title image to the picture image obtained via the camera component 32. The picture image with an attached title image can be produced by performing combination editing or performing the composed editing of the line drawing file and the photographed image file. Thus, a line drawing can be displayed superimposed on a moving image or on a still image input via the camera component 32.

In the image recording and replay apparatus of the invention, a line drawing that is drawn by the operator also includes mid-process line drawings so that it appears as if the operator is actually drawing directly on the screen. Accordingly, for example, when the line drawing is used as a title image, the line drawing is gradually drawn on the screen, so that dramatic expression is possible in which anticipation is heightened. Text, including typed letters (e.g., input by a keyboard) can also be sequentially drawn using the invention.

By making the recording of the position coordinates automatically end when position coordinates have not been taken in for a certain period, the condition in which the apparatus is waiting for input for a long time is prevented.

When the image drawing operation and the sound replay operation are performed simultaneously, for example, with respect to a line drawing that depicts an image of summer, when that line drawing is replayed, a greater realism (ambiance, or presence) can be offered by simultaneously playing the sound of waves, producing a high level of dramatic effect that makes the user have a feeling of anticipation.

The image drawing speed can be changed automatically in correspondence with the replay period of the sound. For example, when the sound replay period is long, the image drawing speed becomes slow, and when the sound replay period is short, the image drawing speed becomes faster as if performing fast forward replay. Accordingly, a single line drawing can be image-drawn at various speeds, and an interesting product having a highly expressive effect can be obtained freely.

While this invention has been described in conjunction with specific embodiments thereof, it is evident that many alternatives, modifications and variations will be apparent to those skilled in the art. Accordingly, the preferred embodiments of the invention set forth herein are intended to be illustrative, not limiting. Various changes may be made without departing from the spirit and scope of the invention as defined in the following claims.

What is claimed is:

1. An image recording and replay apparatus comprising:
input means for sequentially inputting position coordinates from a screen;
recording means for recording in a memory the position coordinates input by the input means, the recording means also recording information relating to the order in which the position coordinates were input; and
image drawing means for performing image drawing by reading out the position coordinates recorded in the memory by the recording means, and sequentially writing on the screen points corresponding to the position coordinates in the order in which the position coordinates were input by the input means.

2. The apparatus of claim 1, wherein the recording means completes the recording of the position coordinates when no position coordinates have been input by the input means for a predetermined time period.

3. The apparatus of claim 1, further comprising sound replay means for reading out recorded sound data and for replaying sound corresponding to the sound data, and wherein the image drawing means and the sound replay means read out the coordinate positions and the sound data, respectively, in parallel.

4. The apparatus of claim 3, wherein the image drawing means controls the speed at which the image drawing is performed so that a replay time of the image drawing and a replay time of the sound replayed by the sound replay means coincide.

5. The apparatus of claim 3, wherein the sound data is recorded in the same memory in which the position coordinates are recorded and, thus, the sound replay means reads the recorded sound data out from the memory.

6. The apparatus of claim 1, wherein the input means includes a graphical user interface.

7. The apparatus of claim 6, wherein the input means includes a touch tablet incorporating the graphical user interface.

8. The apparatus of claim 1, wherein the apparatus is an electronic camera, the electronic camera including means for converting light images of objects into image signals that are stored in the memory.

9. The apparatus of claim 1, wherein the image drawing means is operable in a first mode and in a second mode, when in the first mode the image drawing means sequentially writes the points on the screen for a particular file in the order in which the position coordinates corresponding to the points were recorded, when in the second mode the image drawing means simultaneously writes all of the points for the particular file on the screen.

10. An image recording and replay apparatus comprising:
a display screen having a graphical user interface through which position coordinates are sequentially input in order;
a position coordinate recorder coupled to the display screen to record in a memory the position coordinates input through the display screen, the position coordinate recorder also recording information relating to the order in which the position coordinates were input; and
an image drawing generator coupled to the display screen to perform image drawing on the display screen by reading out the position coordinates recorded in the memory by the position coordinate recorder, and by sequentially writing on the display screen points corresponding to the position coordinates in the order in which the position coordinates were input.

11. The apparatus of claim 10, wherein the position coordinate recorder completes the recording of the position coordinates for a particular file when no position coordinates have been input for a predetermined time period.

12. The apparatus of claim 10, further comprising a sound replay subsystem that reads out recorded sound data and replays sound corresponding to the sound data, and wherein the image drawing generator and the sound replay subsystem read out the coordinate positions and the sound data, respectively, in parallel.

13. The apparatus of claim 12, wherein the image drawing generator controls the speed at which the image drawing is performed so that a replay time of the image drawing and a replay time of the sound replayed by the sound replay subsystem coincide.

14. The apparatus of claim 10, wherein the display screen includes a touch tablet.

15. The apparatus of claim 10, wherein the apparatus is an electronic camera, the electronic camera including a photographic lens that forms a light image of an object on a photoelectric converter that converts the light image into image signals that are stored in the memory.

16. The apparatus of claim 10, wherein the image drawing generator is operable in a first mode and in a second mode, when in the first mode the image drawing generator sequentially writes the points on the display screen for a particular file in the order in which the position coordinates corresponding to the points were recorded, when in the second mode the image drawing generator simultaneously writes all of the points for the particular file on the display screen.

17. An apparatus comprising:
a display screen having a graphical user interface through which position coordinates are sequentially input in order; and
a position coordinate recorder coupled to the display screen to record in a memory the position coordinates input through the display screen, the position coordinate recorder also recording information relating to the order in which the position coordinates were input.

18. The apparatus of claim 17, wherein the position coordinates represent a line drawing.

19. The apparatus of claim 18, further comprising an image drawing generator coupled to the display screen to perform image drawing on the display screen by reading out the position coordinates recorded in the memory by the position coordinate recorder, and by sequentially writing on the display screen points corresponding to the position coordinates in the order in which the position coordinates were input so that the line drawing is reproduced as if the line drawing is being drawn.

20. The apparatus of claim 17, wherein the position coordinate recorder completes the recording of the position coordinates for a particular file when no position coordinates have been input for a predetermined time period.

21. The apparatus of claim 17, wherein the display screen includes a touch tablet.

22. The apparatus of claim 17, wherein the apparatus is an electronic camera, the electronic camera including a photographic lens that forms a light image of an object on a photoelectric converter that converts the light image into image signals that are stored in the memory.

23. The apparatus of claim 22, wherein the position coordinates represent a line drawing.

24. The apparatus of claim 23, further comprising an image drawing generator coupled to the display screen to perform image drawing on the display screen by reading out the position coordinates recorded in the memory by the position coordinate recorder, and by sequentially writing on the display screen points corresponding to the position coordinates in the order in which the position coordinates were input so that the line drawing is reproduced as if the line drawing is being drawn.

25. A method of recording and replaying images, comprising the steps of:
sequentially inputting position coordinates from a screen;
recording in a memory the input position coordinates and also recording information relating to the order in which the position coordinates were input; and
performing image drawing by reading out the position coordinates recorded in the memory by the recording step, and sequentially writing on the screen points corresponding to the position coordinates in the order in which the position coordinates were input.

26. The method of claim 25, wherein the recording step completes the recording of the position coordinates for a particular file when no position coordinates have been input for a predetermined time period.

27. The method of claim 25, further comprising the steps of:
reading out recorded sound data; and
replaying sound corresponding to the sound data, wherein the image drawing step and the sound data reading step are performed in parallel.

28. The method of claim 27, wherein the image drawing step includes controlling the speed at which the image drawing is performed so that a replay time of the image drawing and a replay time of the sound coincide.

29. The method of claim 25, wherein the inputting step includes inputting the position coordinates using a touch tablet.

30. A method of recording images, comprising the steps of:
sequentially inputting position coordinates from a screen; and
recording in a memory the input position coordinates and also recording information relating to the order in which the position coordinates were input.

31. The method of claim 30, wherein the position coordinates represent a line drawing.

32. The method of claim 31, further comprising the step of performing image drawing on the screen by reading out the position coordinates recorded in the memory and by sequentially writing on the screen points corresponding to the position coordinates in the order in which the position coordinates were input so that the line drawing is reproduced as if the line drawing is being drawn.

33. The method of claim 30, wherein the inputting step includes inputting the position coordinates using a touch tablet.
